(19) United States
(12) Patent Application Publication
(10) Pub. No.: US 2020/0120049 A1
(43) Pub. Date: Apr. 16, 2020

(54) AUTO-REPLY TEXT MESSAGES ON A MOBILE DEVICE

(71) Applicant: GalVan Technologies LLC, Indianapolis, IN (US)

(72) Inventor: Chad Galloway, Indianapolis, IN (US)

(21) Appl. No.: 16/712,195

(22) Filed: Dec. 12, 2019

Related U.S. Application Data
(63) Continuation of application No. PCT/US2018/039963, filed on Jun. 28, 2018.
(60) Provisional application No. 62/526,024, filed on Jun. 28, 2017.
(60) Provisional application No. 62/608,025, filed on Dec. 20, 2017.

(51) Int. Cl. H04L 12/58

(52) U.S. Cl. CPC H04L 51/02; H04W 4/14; H04L 51/10; H04L 51/38

(57) ABSTRACT

A cellphone program is disclosed to allow a user to set up an instant text reply for messages from other cellphone users via a message stating the reason for the user's unavailability. In use, a user can create, save, and select various outgoing messages from their cellphone user interface. The cellphone user then selects the desired instant text reply message that will be automatically sent to other cellphone users attempting to contact them for a predetermined time period. At the end of the time period for operation of the Instant Text Reply, the operation of the cellphone is returned to its ordinary function. The invention can be implemented with a program on the cellphone.

### CROSS-REFERENCE TO RELATED APPLICATIONS

This application is a continuation (PCT Bypass) application of International Patent Application No. PCT/US2018/039963, filed on Jun. 28, 2018, which claims the benefit of U.S. provisional patent application No. 62/526,024, filed Jun. 28, 2017, and U.S. provisional patent application No. 62/608,025, filed Dec. 20, 2017, 2017, the subject matter of each is expressly incorporated by reference.

### FIELD

This description relates to away messages used in instant messaging and auto-reply messages used in mobile devices, such as cell phones.

### BACKGROUND

People use their cell phones to quickly communicate with others. People do not want to wait or wonder why a recipient did not respond right away. A recipient wants to be able to respond promptly in some fashion so the correspondent knows what is going on or does not start to worry since the recipient normally responds right away to the communication.

A prior art feature found in some phones is called “Quick Text” and it features a menu from which the user can choose “canned” (already typed and stored in the phone) responses to send in response to a text message received. In a “Quick Text” capable phone, all the steps to reply to a text message must be done as they are normally done, but with a few extra keystrokes, the user can choose a message that has already been typed instead of having to type a reply message. That is, the user receives a notification that a text (SMS) message has arrived, does a keystroke or two to select the text application program and select the text message to view, does a keystroke to put the phone into reply mode but then the user may do another keystroke to open a menu of canned messages to send as a reply. Typically, this is a keystroke to select an “Options” icon (give a command to open a menu which includes a command “Add Quick Text”). Then another keystroke is required to select the “Add Quick Text” command. This keystroke brings up a list of canned messages that can be selected and sent such as “thanks”, “yes”, “no”, etc. One or more keystrokes or scrolling action or trackball action is then required to select the canned message to send and then another keystroke is required to put the canned message into the reply screen as the message to be sent. Then another keystroke is required to actually send the canned message just selected. That is quite a few keystrokes and requires too much attention to the phone, its display and its keypad. It would be too many keystrokes and diverted attention to do while driving and still drive safely.

A published Korean Patent Abstract of an unexamined Korean Patent application published under publication number 1020040082363 on Sep. 24, 2004 teaches a mobile phone for “automatically making a character response during a conference” so as to automatically inform a cellular caller about a situation where the callee [sic] cannot take the call. When a cellular call is received during a situation when the called party cannot take the call, the called party presses a special button or performs a special manipulation on a key of the mobile phone. A memory stops receiving the call immediately, and a predetermined suitable character string is read from the memory and then sent to a phone number of the caller who made the incoming cellular call.

Recently, a series of ads run by AT&T have raised public awareness of the dangers of texting while driving. Some cellular phone manufacturers are starting to respond. In the iOS6™ operating system which started shipping in iPhones™, iPads™, and iPod™ Touch™ devices in October 2012, there is a Reject a Call With a Text Message feature to reject an incoming cell call with a text message. When an incoming cell call arrives, the traditional Decline and Answer “buttons” (areas of the touchscreen labeled Decline and Answer, respectively) are displayed on the touchscreen of the display. To the right of those buttons, a small phone icon is displayed. Swiping that phone icon upward on the touchscreen causes two more areas or “buttons” to be displayed on the touchscreen, one labeled Reply with Message and the other labeled Remind Me Later. The Remind Me Later button does not send an automated text message reply. It just automatically schedules a reminder to call that person later. Touching the Reply with Message button brings up three canned (pre-typed or predetermined) text messages the user can select from to have the phone automatically send to the caller (the caller is automatically sent to voicemail when the Reply with Message button is touched). The three canned messages are “I'll call you later”, “I'm on my way” and “What's up”. A fourth button labelled Custom allows the user to compose a text on the fly. The canned messages can be changed by going to Settings/Phone/Reply with Message.

There has therefore arisen a need for a simple, fast, safe way for the user of a cell phone to send a predetermined message to a text sender to a sender who is corresponding while the user of the cell phone chooses not to reply to the text.

### SUMMARY

In one aspect, users are able to set customized auto-reply messages. The user can organize one or more contacts into one or more categories. The user can set a global auto-reply message; can set category auto-reply messages for one or more of the categories; and can set personal auto-reply messages for one or more of the contacts. When a text message from a contact is received, at least one of the following is performed: a personal auto-reply message is sent to the contact if the user has set a personal auto-reply message for the contact; a category auto-reply message is sent to the contact if the user has set a category auto-reply message for a category including the contact; and the global auto-reply message is sent to the contact if the user has set the global auto-reply message.

In another aspect, a user can organize contacts into categories; select a category; and set a category auto-reply message for the selected category. The set category auto-reply message is sent to contacts that are organized into the selected category when a text message is received from the contacts that are organized into the selected category.

Implementations of this aspect may include one or more of the following features. For example, the user may be able to select a contact that is organized into the selected category; and to set a personal auto-reply message for the selected contact. The personal auto-reply message is sent to the selected contact when an e-mail is received from the selected contact. The user also may be able to set a global auto-reply message, wherein the global auto-reply message is sent to contacts that are organized into categories for which no category auto-reply message has been set and for which no personal auto-reply message has been set.

In another aspect, a text message client program allows a user to set customized auto-reply messages. The Auto Responder program has a first interface element that allows a user to organize contacts into categories and a second interface element that allows the user to set a category auto-reply message for a category. The set category auto-reply message is sent to contacts that are organized into the category for which the category auto-reply message is set when an e-mail is received from the contacts that are organized into the category for which the category auto-reply message is set.

Implementations of this aspect may include one or more of the following features. For example, the text program may have another interface element that displays contacts in a manner that indicates into which category the contacts are organized. An interface element may be included to allow the user to select a contact; and another interface element may be included to allow the user to set a personal auto-reply message for the selected contact. The personal auto-reply message then is sent to the selected contact when a text message is received from the selected contact. The category auto-reply may be additionally sent to the selected contact when a text message is received from the selected contact. Alternatively, a category auto-reply message is sent to a contact only when a personal auto-reply has not been set for the contact.

The text program may include an interface element that allows the user to set a global auto-reply reply message, which is sent to contacts that are organized into categories for which a category auto-reply message has not been set. The category auto-reply may be additionally sent to the selected contact when a text message is received from the selected contact.

Implementations of the foregoing aspects also may include one or more of the following features. For example, an interface may display representations of the categories and representations of the contacts, which may be displayed in a manner that indicates which contacts are organized into which categories.

Setting a personal auto-reply message may include setting a personal auto-reply message that will be appended as an additional message on to a category auto-reply message if the category auto-reply message has been set for the category into which the contact is organized. Alternatively, setting a personal auto-reply message may include setting a personal auto-reply message that will sent in addition to a category auto-reply message if the category auto-reply message has been set for the category into which the contact is organized. Alternatively, setting a personal auto-reply message comprises setting a personal auto-reply message for a contact that will be sent in place of the category auto-reply message associated with the category into which the contact is organized.

Similarly, setting a category auto-reply message may include setting a category auto-reply message that will be appended as an additional message on to the global auto-reply message. Alternatively, setting a category auto-reply message comprises setting a category auto-reply message that will be sent in addition to the global auto-reply message. Alternatively, setting a category auto-reply message comprises setting a category auto-reply message that will be sent in place of the global auto-reply message.

Implementations of the described techniques may include hardware, a method or process, or computer software on a computer-accessible medium.

The details of one or more implementations are set forth in the accompanying drawings and the description below. Other features will be apparent from the description and drawings, and from the claims.

### BRIEF DESCRIPTION OF THE DRAWINGS

The above-mentioned and other features of this disclosure, and the manner of attaining them, will become more apparent and the disclosure itself will be better understood by reference to the following description of embodiments of the disclosure taken in conjunction with the accompanying drawings, wherein:

FIG. 1 is a flowchart of the actions of the Auto Responder program according to an exemplary embodiment of the present disclosure.

FIG. 2 is another flowchart of the actions of the Auto Responder program when signal is low, when roaming, or when on a piggyback network.

FIG. 3 is an illustration of the Auto Responder mobile application.

FIG. 4 is an illustration of the Auto Responder shortcut on a mobile device. The Auto responder icon is in the bottom left corner.

FIG. 5 is an illustration of the settings in the Auto Responder mobile app.

FIG. 6 is an illustration of the driver mode in the Auto Responder mobile app.

FIG. 7 is an illustration of the message log in the Auto Responder mobile app.

Corresponding reference characters indicate corresponding parts throughout the several views. Although the drawings represent embodiments of the present disclosure, the drawings are not necessarily to scale and certain features may be exaggerated in order to better illustrate and explain the present disclosure.

### DETAILED DESCRIPTION OF THE EXEMPLARY EMBODIMENTS

The embodiments disclosed below are not intended to be exhaustive or limit the disclosure to the precise forms disclosed in the following detailed description. Rather, the embodiments are chosen and described so that others skilled in the art may utilize their teachings.

A conventional cell phone, preferably one which includes the identity of the sender who is in the address book of the owner of the cell phone, is modified to implement the teachings of the invention. The modification involves having a program which can be implemented to automatically send a predetermined text message to the sender. The Auto Responder program is useful if the user chooses not to immediately answer the text while otherwise engaged. In some embodiments, the Auto Responder program might be launched manually by the user before he or she becomes otherwise engaged. In other embodiments, the Auto Responder program is automatically launched after a predetermined period of time or lack of inactivity. In other embodiments, the Auto Responder program is automatically launched when the phone is booted up.

The Auto Responder program can either include a new button or buttons added to the phone or to the keypad of the phone or already existing buttons on the phone or keypad of the phone. In some embodiments, the outgoing message can be fixed such as “I am busy right now and will respond later”. In other embodiments, the outgoing automated message can be selected by the user during configuration of the Auto Responder program or selection of a number of different “canned” messages supplied by the Auto Responder program. In configurable message embodiments, the user can pick the message to be sent or played before they became otherwise engaged such as start a meeting.

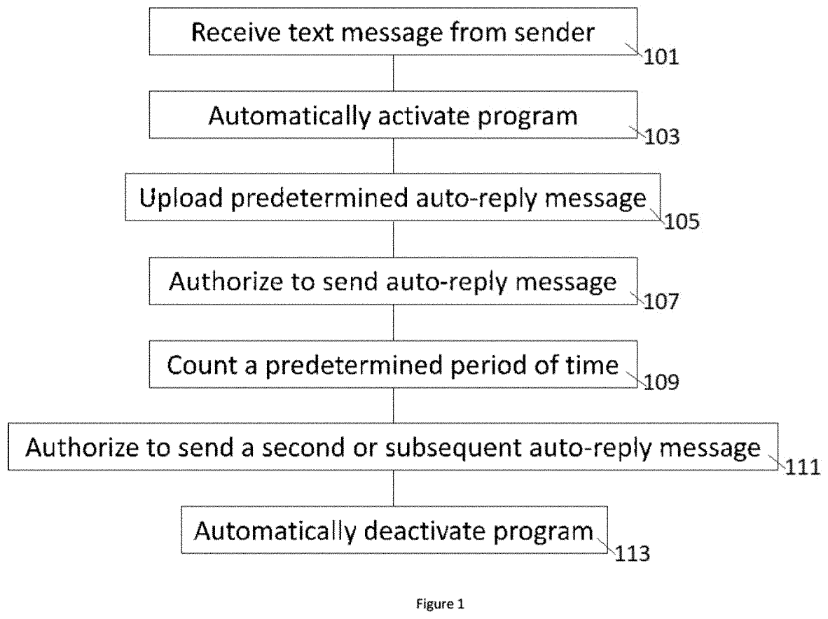

As illustrated in FIG. 1, in the exemplary embodiment the series of functions performed by the Auto Responder program 131 are to: receive text message from sender 101; automatically activate program 103; upload a predetermined message 105; and authorize to send auto-reply message 107, count a pre-determined period of time 109 to send the predetermined message 106, authorize to send a second or subsequent auto-reply message 111, and then deactivate program 113.

In one embodiment, the series of functions performed by the Auto Responder program 131 are to: select the text message/SMS or MMS message just received 102; put the SMS application in reply mode 140; upload a predetermined message 105; and give the operating system a send command 107 to send the predetermined message 106. In the Auto Responder program 131, a text message is automatically responded to with a predetermined reply message that the owner of the phone is otherwise engaged and cannot respond to a text message which has just been received.

In one embodiment, an incoming text message is responded to automatically which causes the incoming text message to be replied to inform the sender that the owner of the cell phone is busy and cannot correspond with the sender at the moment.

The technology varies from phone to phone in terms of the type of software and the function calls made to manipulate the operating system, SMS application and phone applications which implement the Auto Responder program. Basically, the Auto Responder program functions, when triggered, to do whatever is necessary on the host phone to give the appropriate commands to designate the text message to which an automated reply is being sent, select it and enter the reply mode 140, enter the pre-recorded text message and, finally, to automatically give the send command. All processes which work for whatever phone the technology is implemented on are intended to be covered by the Auto Responder program.

The message that is sent to respond to an incoming text just received could be anything. “I am driving and cannot respond immediately” is one example. “Out of Office” is another example.

In some embodiments, only the text of the automated reply message is entered automatically. In another embodiment, the command to launch a macro or program to automatically enter the text of the reply message also includes automatically giving the send command after the text of the automated reply message has been entered.

FIG. 1 is a block diagram of the environment of the teachings of the disclosure and a block diagram of a broad concept according to the Auto Responder program defining a functionality. A cell phone 133 which is capable of sending and receiving text messages has circuitry and software which is conventional for sending and receiving text messages and making and receiving phone calls but which is modified with a program. The Auto Responder program includes a button or “key” on the cell phone or on the “keypad” or “keyboard” which can be pushed when the user of the cell phone is otherwise busy and receives an incoming text message to which the user cannot or does not wish to respond to immediately.

The Auto Responder program also comprises whatever circuitry and/or software which is necessary for the particular host cell phone to, in the case of an incoming text message: 1) to automatically engage the Auto Responder program 131; 2) select the text message which has just been received 102; 3) do whatever is necessary for the particular host cell phone in which the Auto Responder program technology is resident to put the cell phone in reply mode 140 to reply to the text message just received; 4) do whatever is necessary for the particular host cell phone in which the Auto Responder program technology is resident to automatically enter characters of a reply text message that informs the sender of the text message that the recipient is busy and cannot respond immediately; and 5) do whatever is necessary for the particular host cell phone in which the Auto Responder program technology is resident to give the command to send the text message.

As illustrated in FIG. 1, the Auto Responder program also allows to set a predetermined time period 109 between the receipt of an incoming text message and sending an auto-reply text message 111. A default time period 108 can be for example 1 minute, which can be increased or decreased in 30 second increments.

The Auto Responder program also allows to set a plurality of predetermined time periods. For example, a first predetermined time period 109 of two minutes since receipt of an incoming text message and sending an auto-reply text message may be set. Second 110, third 127, and fourth 129 predetermined time periods of 10 minutes, 30 minutes and 1 hour, respectively, may be set.

The message that is sent may be tailored to correspond to a predetermined time period. For example, first predetermined time period 109 may provide a message 106 such as “Auto-Reply by [Program name]: Please know that I have not read your message yet. I might be on the phone or tied up, however I will reply as soon as I get a chance. Thanks.”. Second predetermined time period 110 may provide a message 112 such as “Auto-Reply by [Program name]: I apologize for not replying yet. I still am tied up either on the phone or in a meeting. I will however reply as soon as I can. Thanks.”. Third predetermined time period 127 may provide a message 128 such as “Auto-Reply by [Program name]: I apologize for not replying yet. If urgent please contact my office manager [Name] at [phone number]. Thanks again.”. Fourth predetermined time 129 period may provide a message 130 such as “I have not overlooked your text message. I am rarely unavailable for this amount of time. I must be traveling or in a bad cell area. Please either contact my office or I will get back to you asap. Thanks.”.

Each auto-reply message may also provide information about the Auto Responder program and a link to download the Auto Responder program from an app store. “Get your [program name] go to: [program ID] at [online app store website]” is one example.

The terms “button,” “key,” “keypad” and “keyboard” in embodiments described herein include not only physical keys and keyboards such as are found on most cell phones but also on touch sensitive areas on the desktops or any display such as the display of the keyboard on touchscreen cell phones or smartphones.

There can be a single key for the Auto Responder program which is context sensitive and does whatever is necessary to respond to an incoming text message which was just received, depending upon which was received, or there can be a key to respond to text messages just received.

Text messages may be Short Message Service (SMS) or Multimedia Messaging Service (MMS), or any other form in the art.

Text messages of the SMS are methods of communication that send text between cell phones or from a PC to a cell phone. SMS messages are limited to 160 characters total. Even if a person is not talking on their cell phone, the phone is periodically sending and receiving information. It is talking to its cell phone tower over a data pathway called a control channel modulated onto a radio carrier. The reason for this chatter is so that the cell provider knows which cell your phone is in so that it can be found for incoming calls or texts, and so that the cell phone can change cell towers as it moves around. Every so often, the phone and the tower exchange a packet of data that lets both of them know everything is in good working order and who is where in the cell system. This is called a handshake.

MMS is an evolution of the SMS. With a MMS, you can send a message including pictures, video, or audio content to another device. MMS is most commonly used to send a photo taken with a camera phone to another phone. Most new cell phones with multimedia capabilities support MMS.

The cell phone also uses the control channel for call setup. When someone tries to call your phone, the cell tower sends your phone a message over the control channel telling your phone to play its ringtone. The tower in cell system 16 also gives your phone a pair of voice channel frequencies, one to transmit on and one to receive on, for full duplex communication. The control channel also provides the digital data pathway for SMS messages and router 5 which routes packets of digitized voice data and also routes packets of SMS data. Internet web browsing and e-mail are different digital data pathways that are separate from the data pathways used to send and receive digitized voice data and SMS messages. Data router 40 is actually in the web and e-mail data pathway of the cell system 16 and is used by the cell phone 10 to send and receive e-mail messages and to browse the worldwide web.

General Packet Radio Services (GPRS) is an older wireless network data transfer protocol for smartphones that is a packet based communication service. It is a 2.5G protocol that was the standard till recently. It is a packet-switched, always-on connection that remains active as long as the phone is within range of a tower. It allows the smartphone to do things like run applications remotely over the network, interface with the internet, participate in instant messenger sessions, act as a wireless modem for a computer and transmit and receive e-mails. It is limited to 114 kilobytes per second, so it has been replaced by Enhanced Data GSM Environment (EDGE) protocols which can transmit at 384 kbps, but it is still a 2.5G protocol. 3G protocols transmit data in megabits per second (some as fast as 10 Mbps) and are taking over. Some US carriers. offer 3G protocols (EVDO). NTT DoCoMo Inc. tested a 4G protocol Feb. 9, 2007 that is 500 times faster than 3G protoocols, and those protocols will eventually take over. The teachings of the invention may be employed in all these protocols.

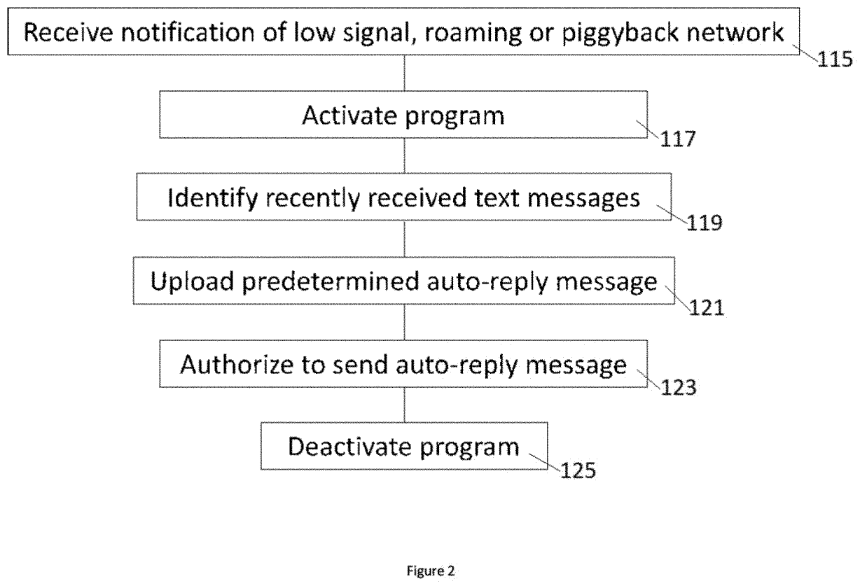

As illustrated in FIG. 2, the Auto Responder program may be activated when the cellphone's signal is low, when the cell phone is roaming or when the cell phone is relying on a piggyback 115. The Auto Responder program is automatically activated 117 or deactivated 125. The Auto Responder program is triggered by a text message that is received but not opened for a pre-determined period of time 119.

The Auto Responder program may send a message 123 to recent text message senders informing the senders that the user may not be able to respond immediately due to loss of signal, preference to not communicate on a roaming network or preference not to communicate by piggybacking on another cell phone's signal. Relevant messages such as “Thank you for your recent text message. My cell phone has low signal and I might lose network connection soon. I will reply as soon as I get a chance. Thanks.”, “My cell phone is roaming and I prefer to not provide substantive communication on an unknown network. I will reply as soon as I get a chance. Thanks.”, or “My cell phone is piggybacking on another device's signal. I prefer to not provide substantive communication using an unknown network. Thanks.”, respectively, may be sent.

The Auto Responder program may also send an auto-reply message when a received text message is being accessed by the user of the cell phone. “Thank you for your recent text message. I accessed your text message and will reply as soon as I get a chance. Thanks.” is one example.

The Auto Responder program may be able to set an auto-reply option for a single category, multiple categories or global auto-reply. The Auto Responder program also may exempt categories from the global auto-reply. At times, however, the Auto Responder program can be structured such that no auto-replies, category or global, are sent to a particular category. A global auto-reply message will not be sent to those contacts in the selected exempt categories.

An instant message recipient may receive multiple instant messages from multiple senders. Similarly, an owner of a cell phone may send an instant message to multiple recipients. The Auto Responder program may also allow for multiple responses to instant messages at different time intervals.

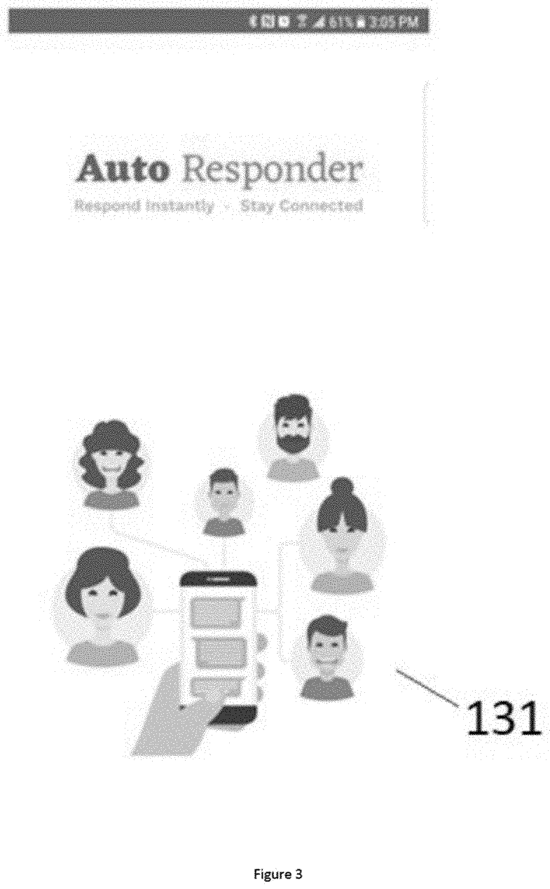

As illustrated in FIG. 3, the Auto Responder program 131 is a mobile application.

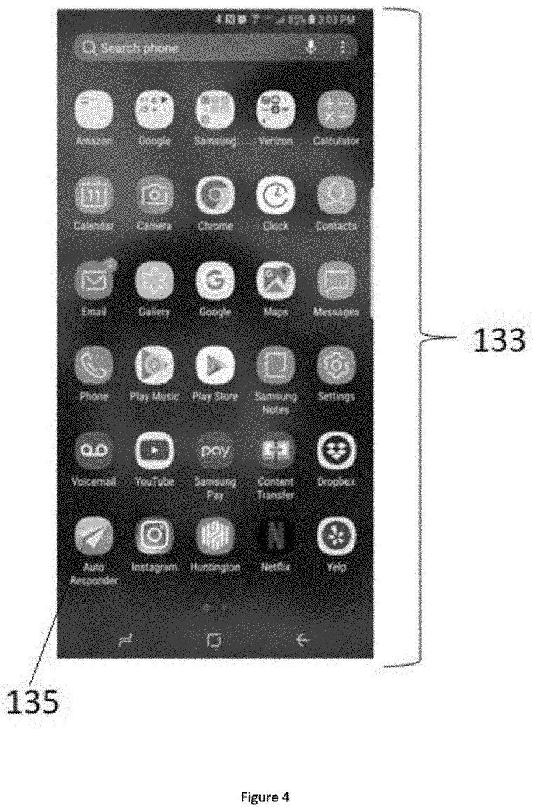

As illustrated in FIG. 4, the Auto Responder program 131 includes a shortcut 135 on a mobile device 133.

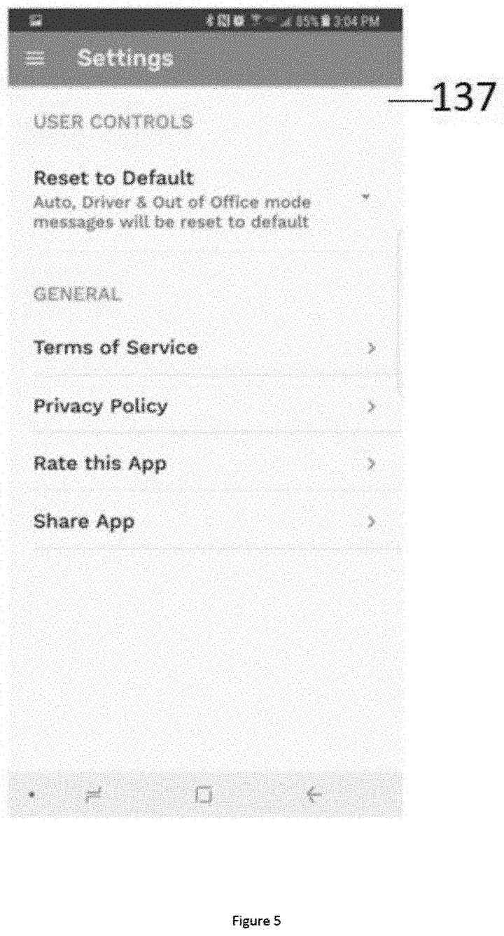

As illustrated in FIG. 5, the settings 137 in the Auto Responder mobile app 131 include user controls to customize auto reply messages.

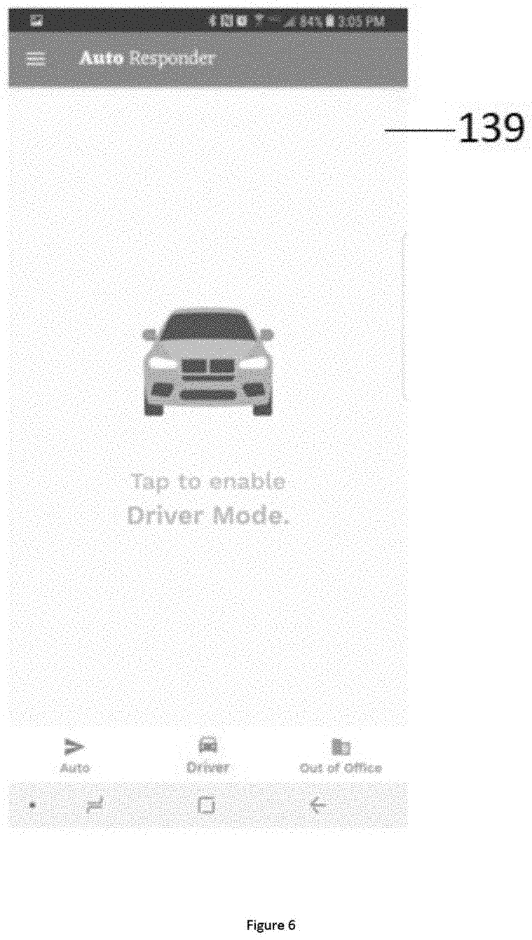

As illustrated in FIG. 6, the user can tap to enable driver mode 139 in the Auto Responder mobile app 131.

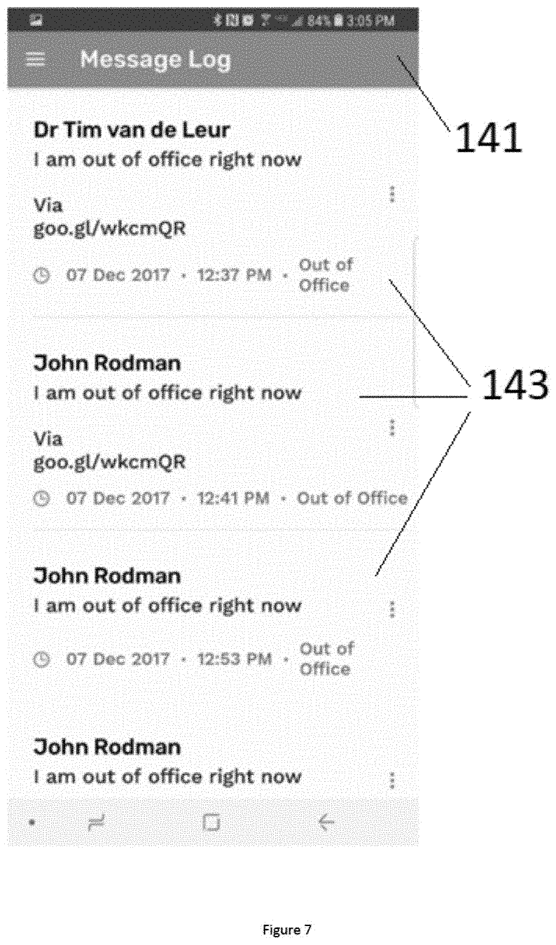

As illustrated in FIG. 7, the message log 141 in the Auto Responder mobile app 131 archives individual messages 143.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

What is claimed is:

1. A method for automatically responding to text messages received by a cellphone, comprising:
activating an auto-reply program on the cellphone;
wherein the program responds to text messages directed to the cellphone with the auto-reply text message, wherein the program is further used to create a single category or multiple categories.

2. The method of claim 1, wherein the program on the cellphone are further used to create and save new auto-reply messages.

3. The method of claim 1, wherein the program is activated for a predetermined period of time.

4. The method of claim 3, further comprising returning the cellphone to a default operation upon expiration of the predetermined time.

5. The method of claim 3, further comprising returning the cellphone to a default operation upon user deactivation of the auto-reply message.

6. The method of claim 3, wherein the program on the cellphone is further used to select the predetermined period of time.

7. The method of claim 3, wherein the program on the cellphone is further used to create and save new auto-reply messages.

8. The method of claim 1, wherein activating an auto-reply message further comprises selecting the auto-reply message from a list of saved auto-reply messages.

9. The method of claim 8 wherein the program on the cellphone is further used to select the auto-reply message from a list of saved auto-reply messages.

10. (canceled)

11. A method for automatically responding to text messages received by a cellphone, comprising:
activating an auto-reply program on the cellphone;
wherein the program responds to text messages directed to the cellphone with the auto-reply text message wherein the program is further used to create a global auto-reply.

12. The method of claim 11, wherein the program is further used to create an exempt category from the global auto-reply.

13. The method of claim 12, wherein the exempt category is structured such that no auto-replies are sent to a particular category.

14. A method for automatically responding to text messages received by a cellphone, comprising:
activating an auto-reply program on the cellphone;
wherein the program responds to text messages directed to the cellphone with the auto-reply text message, wherein responding to text messages includes responding to multiple senders.

15. The method of claim 11, wherein the program is further used to set time intervals for responding.

16. The method of claim 15, wherein the program is further used to set different time intervals.

17. The method of claim 1, wherein the program is further used to create multiple responses.
